(19) United States
(12) Patent Application Publication
(10) Pub. No.: US 2025/0059901 A1
(43) Pub. Date: Feb. 20, 2025

(54) EXHAUST THERMAL MANAGEMENT HEATING STRATEGY FOR OPTIMAL NOx REDUCTION AND NH3 STORAGE ON A SELECTIVE CATALYTIC REDUCTION CATALYST

(71) Applicant: Eaton Intelligent Power Limited, Dublin 4 (IE)

(72) Inventors: James E. MCCARTHY, Jr., Kalamazoo, MI (US); Bryan A. ZAVALA, San Antonio, TX (US); Chris SHARP, San Antonio, TX (US); Andrew MATHEAUS, San Antonio, TX (US)

(21) Appl. No.: 18/717,711

(22) PCT Filed: Dec. 8, 2022
(86) PCT No.: PCT/EP2022/025562

§ 371 Date: Jun. 7, 2024

Related U.S. Application Data
(60) Provisional application No. 63/287,513, filed on Dec. 8, 2021.

(51) Int. Cl. F01N 3/20

(52) U.S. Cl. CPC F01N 3/208

(57) ABSTRACT

A method of aftertreatment heat management involves heating a selective catalytic reduction (SCR) device of an aftertreatment system to a temperature of 225° C.+/−15° C. This temperature optimizes for both NOx reduction and NH; storage. A fuel burner or e-Heater can be used to heat the SCR to the desired temperature and, in some cases, increase the temperature to a target temperature of around 250° C. for a period of time to release excess NH3 from the SCR.

### BACKGROUND

There is an optimal amount of heat required for a diesel Selective Catalytic Reduction (SCR) catalyst to perform nitrogen oxide (NOₓ) reduction. Selective Catalytic Reduction, or SCR, reactions are dependent on exhaust temperature, reductant quantity (NH₃), NOₓ species, and space velocity. In general, NOₓ conversion is optimal between 250° C. and 450° C. However, in practice, NOₓ tailpipe performance does not reflect this expected optimal conversion for NOₓ by the SCR.

### BRIEF SUMMARY

Exhaust thermal management heating strategies are described. Optimal NO tailpipe performance is possible by taking into account NH₃ storage loss at the SCR. Instead of optimizing only for NOₓ reduction, it has been found that temperatures above 200° C. and below 250° C. enable optimization of both NOₓ reduction and NH₃ storage, providing improved NOₓ tailpipe performance.

A method of aftertreatment heat management includes heating a selective catalytic reduction (SCR) device of an aftertreatment system to a temperature of 225° C.+/−15° C. A fuel burner or e-Heater (electric heater) can be used to heat the SCR to the desired temperature and, in some cases, increase the temperature to a target temperature of around 250° C. for a period of time to release excess NH₃ from the SCR.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a simplified representation of an operating environment of a diesel engine aftertreatment system with the described exhaust thermal management.

FIGS. 2A and 2B show NH₃ storage and NOₓ conversion vs. temperature. FIG. 2A shows NH₃ storage decreases as temperature increases. FIG. 2B illustrates a target temperature range for optimal NH₃ storage and NOₓ conversion.

### DETAILED DESCRIPTION

Exhaust thermal management heating strategies are described. Optimal NOₓ tailpipe performance is possible by taking into account NH₃ storage loss at the SCR. Instead of optimizing only for NOₓ reduction, it has been found that temperatures above 200° C. and below 250° C. enable optimization of both NOₓ reduction and NH₃ storage, providing improved NOₓ tailpipe performance.

As mentioned above, there is an optimal amount of heat required for a diesel SCR catalyst of an engine exhaust aftertreatment system. Although NOₓ conversion is optimal between 250° C. and 450° C., ammonia (NH₃) storage on the SCR dramatically reduces when the temperature exceeds 250° C. If there is less NH₃ on the catalyst, then NOₓ conversion suffers due to lack of NH₃. In the example presented herein, it is shown that using an e-Heater (electric heater) or fuel burner is optimal to heat the SCR to around 225° C. to maximize both NOₓ reduction and maintain NH₃ storage. The particular optimal temperature can vary slightly with catalyst formulation and application. Hence, in most cases, a temperature of 225° C.+/−15° C. is optimal.

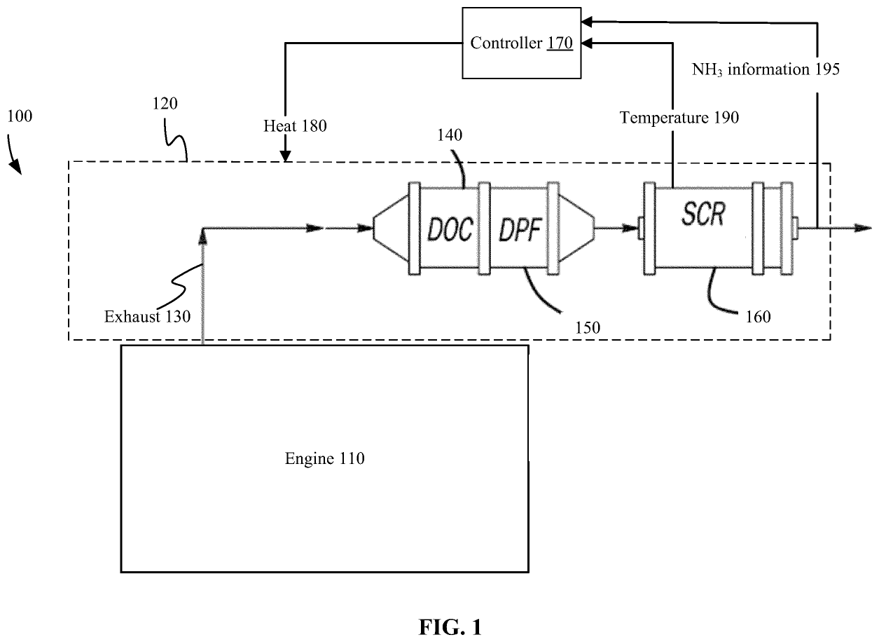

FIG. 1 illustrates a simplified representation of an operating environment of a diesel engine aftertreatment system with the described exhaust thermal management. Referring to FIG. 1, environment 100 includes an engine 110, an aftertreatment system 120, and a controller 170. The engine 110 releases exhaust 130 which is directed to the aftertreatment system 120. The aftertreatment system 120 includes a selective catalytic reduction (SCR) device 160. In some cases, the aftertreatment system 120 further includes a diesel oxidation catalyst (DOC) 140 and a diesel particulate filter (DPF) 150. In some cases, the aftertreatment system 120 includes additional components.

As discussed herein, it is important to heat the SCR 160 to maximize NOₓ reduction and maintain NH₃ storage. To heat the SCR 160 of the aftertreatment system 120 to the desired temperature, heat 180 (with temperature and flow) is applied to the aftertreatment system 120. In some cases, a source of the heat 180 is applied at the SCR 160. In some cases, a source of the heat 180 is applied at another location in the aftertreatment system 120. In some cases, a source of the heat 180 is applied by an exhaust heating device (not shown). The exhaust heating device can be located outside of the aftertreatment system 120 or within the aftertreatment system 120. In some cases, the exhaust heating device is an e-Heater. In some cases, the exhaust heating device is a fuel burner.

The controller 170 can be one or more standalone controllers and/or incorporated in various controllers in or associated with a vehicle. The controller 170 includes a processor and memory. The processor can include one or more of any suitable processing devices (“processors”), such as a microprocessor, central processing unit (CPU), field programmable gate arrays (FPGAs), application-specific integrated circuits (ASICs), logic circuits, and state machines. Memory can include any suitable storage media that can store instructions (e.g., to carry out methods of aftertreatment heat management disclosed herein). Example storage media include, but are not limited to, read only memory (ROM), random access memory (RAM), flash, magnetic memory, and the like. In some cases, a computer-readable medium can be provided that stores instructions for performing the temperature management techniques described herein. As used herein “memory,” “storage media,” and “computer-readable storage medium” do not consist of transitory, propagating waves.

The controller 170 receives, via one or more temperature sensors (not shown), temperature information 190 from the aftertreatment system 120. In some cases, the temperature information 190 is the SCR 160 temperature. In some cases, the controller 170 also receives, via one or more NH₃ sensors (not shown), NH₃ information 195 from the aftertreatment system 120, where the NH₃ information 195 indicates an amount of NH₃ released from the SCR 160 (which can be used to infer the NH₃ stored on the SCR).

The controller 170 uses the temperature information 190, the NH₃ information 195, and optionally additional information about the system when executing the instructions, to carry out a method of aftertreatment heat management as described herein, which are stored on the memory. In some cases, the controller 170, when executing the instructions stored on the memory, causes the SCR device to be heated to a temperature of 225° C.+/−15° C. For example, the controller 170, when executing the instructions stored in its memory, can set a SCR target temperature of 225° C.+/−15 degrees for operating one or more exhaust heating devices such as an e-Heater or fuel burner that may be used to apply heat 180 to the system.

As mentioned above, the controller 170 can receive NH₃ information (e.g., NH₃ information 195 of FIG. 1) released from the SCR (e.g., SCR 160 of FIG. 1). In some cases, if the SCR has an excessive amount of NH₃ on it (as determined based on the NH₃ information 195), then raising the target temperature slightly to 250° C., for example, would be acceptable for a short period of time (e.g., 30 to 120 seconds). Thus, when the controller 170 determines (e.g., from the NH₃ information 195 of FIG. 1) that there is an excessive amount of NH₃ in the SCR (e.g., above a threshold), the method of aftertreatment heat management of an aftertreatment system (e.g., aftertreatment system 120 of FIG. 1) may include directing an exhaust heating device (e.g., e-Heater or fuel burner) to heat the SCR to approximately 225° C. (e.g., 225° C.+/−15° C.) and once the SCR is determined to have an amount of NH₃ on it above the threshold, raising the temperature to a target temperature of 250° C. for a period of time. In some cases, the period of time is between 30-120 seconds. The controller can cause the SCR device to be heated to the target temperature by controlling the application of heat to the SCR based on received temperature information. In some cases, the controller controls an exhaust heating device in order to raise the SCR device to the target temperature.

For the configuration of SCR catalyst tested, it can be shown that NOₓ performance deteriorates as the heat moves from 250° C., to 275° C., or 300° C. Therefore, a SCR target temperature window is important to maintain for optimal NOₓ tailpipe (TP) performance. Accordingly, the described method can include receiving temperature information of the SCR device; determining, from the temperature information, that the SCR device of the aftertreatment system is at the temperature of 225° C.+/−15° C.; and maintaining the SCR device within the temperature of 225° C.+/−15° C. The controller can cause the SCR device to be maintained at the indicated temperature by controlling the application of heat to the SCR based on received temperature information. In some cases, the controller controls an exhaust heating device in order to maintain the SCR device at the desired temperature.

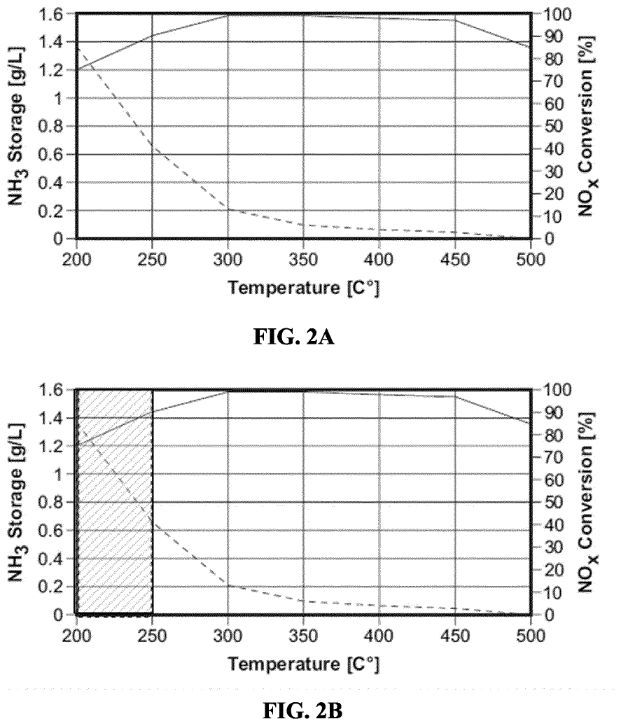

The following describes an SCR catalyst temperature control strategy utilizing an in-exhaust heater. The SCR catalyst temperature control strategy may be performed by controller 170 of FIG. 1. The strategy is dependent on knowledge of the formulation specific NOₓ conversion curve and NH₃ storage capacity. FIG. 2A provides an example of both parameters as a function of catalyst temperature.

FIGS. 2A and 2B show NH₃ storage and NOₓ conversion vs. temperature. FIG. 2A shows NH₃ storage decreases as temperature increases. FIG. 2B illustrates a target temperature range for optimal NH₃ storage and NOₓ conversion. As can be seen in FIG. 2B, a temperature range between 20° and 250° C. is ideal yield optimal NH₃ storage while still maintaining suitable NOₓ conversion.

During a cold start, the SCR catalyst is at a non-ideal condition for NOₓ reduction. In current and future powertrain technologies, the engine (e.g., engine 110 of FIG. 1) enters a thermal management mode, which aims to increase the catalyst temperature to an in-service state. Depending in the engine duty cycle, this may take a significant amount of time as the SCR is positioned downstream of other catalysts (e.g., SCR 160, of FIG. 1, may be positioned downstream from DOC 140 and/or DPF 150). Augmenting a heater to the aftertreatment system enables rapid catalyst warm-up (e.g., heat 180 applied to aftertreatment system 120 of FIG. 1), which then allows the SCR to begin reducing NOₓ. The heater is primarily utilized to increase catalyst temperature up to a pre-determined SCR temperature. As shown in the example of FIG. 2B, the SCR temperature target is set between 200° C. and 250° C. It is understood that the example is used for clarification purposes and that the strategy claimed considers the specific SCR formulation. The SCR temperature target considers the following scenarios: (1) SCR temperature target below 200° C. will yield insufficient NOₓ conversion; (2) SCR temperature target above 250° C. can desorb a significant amount of NH₃, which may oxidize to NOₓ in a downstream catalyst or be released as NH₃ into the TP; and (3) SCR temperature target above 250° C. may incur a higher fuel consumption penalty on the engine because of over utilizing the heater.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method of aftertreatment heat management, comprising:
heating a selective catalytic reduction (SCR) device of an aftertreatment system to a temperature of 225° C.+/−15° C.

2. The method of claim 1, wherein heating the SCR device of the aftertreatment system to a temperature of 225° C.+/−15° C. comprises applying heat to the aftertreatment system using an exhaust heating device.

3. The method of claim 2, wherein the exhaust heating device is positioned within the aftertreatment system.

4. The method of claim 2, wherein the exhaust heating device is an e-Heater.

5. The method of claim 2, wherein the exhaust heating device is a fuel burner.

6. The method of claim 1, further comprising:
receiving temperature information of the SCR device;
determining, from the temperature information, that the SCR device of the aftertreatment system is at the temperature of 225° C.+/−15° C.; and
maintaining the SCR device within the temperature of 225° C.+/−15° C.

7. The method of claim 1, further comprising:
receiving NH₃ information released from the SCR device;
determining, from the NH₃ information, that there is an amount of NH₃ at the SCR device above a threshold; and
in response to determining that there is the amount of NH₃ above the threshold, heating the SCR device of the aftertreatment system to a temperature of 250° C. for a period of time.

8. The method of claim 7, wherein the period of time is between 30-120 seconds.

9. A system, comprising:
an aftertreatment system comprising a selective catalytic reduction (SCR) device; and
a controller comprising a processor and memory, the memory storing instructions that when executed by the controller, direct the system to:
heat the SCR device to a temperature of 225° C.+/−15° C.

10. The system of claim 9, wherein the instructions further direct the system to:
receive temperature information of the SCR device;
determine, from the temperature information, that the SCR device of the aftertreatment system is at the temperature of 225° C.+/−15° C.; and
maintain the SCR device within the temperature of 225° C.+/−15° C.

11. The system of claim 9, wherein the instructions further direct the system to:
receive NH₃ information released from the SCR device;
determine, from the NH₃ information, that there is an amount of NH₃ at the SCR device above a threshold; and
in response to determining that there is the amount of NH₃ above the threshold, heat the SCR device of the aftertreatment system to a temperature of 250° C. for a period of time.

12. The system of claim 11, wherein the period of time is between 30-120 seconds.

13. The system of claim 9, further comprising an exhaust heating device, wherein the instructions directing the system to heat the SCR device to a temperature of 225° C.+/−15° C. comprise directing the exhaust heating device of the system to apply heat to the system.

14. The system of claim 13, wherein the exhaust heating device is an electric heater.

15. The system of claim 13, wherein the exhaust heating device is a fuel burner.

16. A computer readable medium comprising instructions stored thereon that cause a controller to perform a method of:
heating a selective catalytic reduction (SCR) device of an aftertreatment system to a temperature of 225° C.+/−15° C.

17. The computer readable medium of claim 16, further comprising instructions that cause the controller to further perform the method of:
receiving temperature information of the SCR device;
determining, from the temperature information, that the SCR device of the aftertreatment system is at the temperature of 225° C.+/−15° C.; and
maintaining the SCR device within the temperature of 225° C.+/−15° C.

18. The computer readable medium of claim 17, further comprising instructions that cause the controller to further perform the method of:
receiving NH₃ information released from the SCR device;
determining, from the NH₃ information, that there is an amount of NH₃ at the SCR device above a threshold; and
in response to determining that there is the amount of NH₃ above the threshold, heating the SCR device of the aftertreatment system to a temperature of 250° C. for a period of time.

19. The computer readable medium of claim 18, wherein the period of time is between 30-120 seconds.
